(19) United States
(12) Patent Application Publication
(10) Pub. No.: US 2024/0326861 A1
(43) Pub. Date: Oct. 3, 2024

(54) POSITION DETECTION APPARATUS AND POSITION DETECTION METHOD

(71) Applicant: Mitsubishi Electric Corporation, Tokyo (JP)

(72) Inventors: Akihiro KAWAKAMI, Tokyo (JP); Yoshiki SAKADANI, Tokyo (JP)

(73) Assignee: Mitsubishi Electric Corporation, Tokyo (JP)

(21) Appl. No.: 18/421,259

(22) Filed: Jan. 24, 2024

(30) Foreign Application Priority Data
Mar. 28, 2023 (JP) 2023-050932

(51) Int. Cl. B60W 60/00

(52) U.S. Cl. CPC B60W 60/001; B60W 2554/4041; B60W 2554/4049

(57) ABSTRACT

To provide a position detection apparatus and a position detection method which can determine a reliability of detection positions of peripheral object parts by each periphery information detector by utilizing that the plurality of periphery information detectors are provided. A position detection apparatus calculates a difference amount between the first relative position and the second relative position, for each of pairs of the first relative position and the second relative position in which relative positions correspond with each other; determines a group of a plurality of the difference amounts calculated for the same object, based on a plurality of the difference amounts; and determines whether or not the reliability of the first relative positions and the second relative positions corresponding to the plurality of difference amounts of the same object is high, based on the plurality of difference amounts of the same object.

### INCORPORATION BY REFERENCE

The disclosure of Japanese Patent Application No. 2023-50932 filed on Mar. 28, 2023 including its specification, claims and drawings, is incorporated herein by reference in its entirety.

### BACKGROUND

The present disclosure relates to a position detection apparatus and a position detection method.

In the technology of JP 2017-138282 A, a position of an ego vehicle is measured; a first ego vehicle position on map is detected based on the measured position of the ego vehicle, and map information corresponding to the measured position of the ego vehicle; a traveling scene of the ego vehicle is identified based on the first ego vehicle position and the map information; a second ego vehicle position is detected by a position detection processing which was previously correlated with the traveling scene, based on detection result of a camera or a radar sensor, and the like; and which ego vehicle position is used for an automatic driving is determined based on a difference of the first ego vehicle position and the second ego vehicle position.

### SUMMARY

By the way, when controlling the ego vehicle, it is necessary to detect not only the ego vehicle position, but also positions of objects which exist around the ego vehicle with good accuracy. However, the technology of JP 2017-138282 A only determines a plurality of ego vehicle positions, but does not disclose a technology of detecting positions of surrounding objects with good accuracy. The technology of JP 2017-138282 A requires identification of the traveling scene, and the traveling scene to be identified is limited.

In the technology of JP 2017-138282 A, the ego vehicle position detected by each method is only one, and mutual comparison is comparatively easy. On the other hand, positions of many and unspecified object parts which exist around the ego vehicle are detected by the periphery information detectors. Accordingly, it is not easy to determine reliability of the plurality of positions of object parts around the ego vehicle detected by each of the plurality of periphery information detectors.

Then, the purpose of the present disclosure is to provide a position detection apparatus and a position detection method which can determine a reliability of detection positions of peripheral object parts by each periphery information detector by utilizing that the plurality of periphery information detectors are provided, when the positions of the plurality of object parts which exist around an ego vehicle is detected based on each detection information of the plurality of periphery information detectors.

A position detection apparatus according to the present disclosure, including:
a periphery information acquisition unit that detects, for each of a plurality of periphery information detectors, relative positions of a plurality of object parts existing around an ego vehicle with respect to the ego vehicle, based on detection information of the periphery information detector;
a difference amount calculation unit that sets a first periphery information detector and a second periphery information detector to be determined, from the plurality of periphery information detectors; sets the relative positions of the plurality of object parts which were detected based on the detection information of the first periphery information detector, as a plurality of first relative positions; sets the relative positions of the plurality of object parts which were detected based on the detection information of the second periphery information detector, as a plurality of second relative positions; and calculates a difference amount between the first relative position and the second relative position, for each of pairs of the first relative position and the second relative position in which relative positions correspond with each other; and
a reliability determination unit that determines a group of a plurality of the difference amounts calculated for the same object, based on a plurality of the difference amounts, and determines whether or not a reliability of the first relative positions and the second relative positions corresponding to the plurality of difference amounts of the same object is high, based on the plurality of difference amounts of the same object of one group which was determined to be calculated for the same object.

A position detection method according to the present disclosure that makes an arithmetic processor perform each following step, including:
a periphery information acquisition step of detecting, for each of a plurality of periphery information detectors, relative positions of a plurality of object parts existing around an ego vehicle with respect to the ego vehicle, based on detection information of the periphery information detector;
a difference amount calculation step of setting a first periphery information detector and a second periphery information detector to be determined, from the plurality of periphery information detectors; setting the relative positions of the plurality of object parts which were detected based on the detection information of the first periphery information detector, as a plurality of first relative positions; setting the relative positions of the plurality of object parts which were detected based on the detection information of the second periphery information detector, as a plurality of second relative positions; and calculating a difference amount between the first relative position and the second relative position, for each of pairs of the first relative position and the second relative position in which relative positions correspond with each other;
a reliability determination step of determining a group of a plurality of the difference amounts calculated for the same object, based on a plurality of the difference amounts, and determining whether or not the reliability of the first relative positions and the second relative positions corresponding to the plurality of difference amounts of the same object is high, based on the plurality of difference amounts of the same object of one group which was determined to be calculated for the same object.

According to the position detection apparatus and the position detection method of the present disclosure, the first periphery information detector and the second periphery information detector to be determined is set from the plurality of periphery information detectors; and the difference amount between the first relative position and the second relative position is calculated for each of pairs of the first relative position and the second relative position in which relative positions correspond with each other; even for the difference amount between the first relative position and the second relative position in which relative positions correspond with each other, the difference amount calculated for not same objects becomes large or its variation amount becomes large. Accordingly, if the reliability of the first and the second relative positions is determined using the difference amounts of not same objects, it may be erroneously determined that the reliability is low. The group of the plurality of the difference amounts calculated for the same object is determined based on the plurality of the difference amounts; and the reliability of the first relative positions and the second relative positions corresponding to the plurality of difference amounts of the same object is determined based on the plurality of difference amounts of one group which was determined to be calculated for the same object. Accordingly, the reliability can be determined with good accuracy. Therefore, by utilizing that the plurality of periphery information detectors are provided, the reliability of the detection positions of the peripheral object parts by each periphery information detector can be determined.

### BRIEF DESCRIPTION OF THE DRAWINGS

FIG. 1 is a schematic block diagram of the position detection apparatus and the vehicle control apparatus, according to Embodiment 1;

FIG. 2 is a schematic hardware configuration figure of the position detection apparatus and the vehicle control apparatus, according to Embodiment 1;

FIG. 3 is a schematic hardware configuration figure of the position detection apparatus and the vehicle control apparatus, according to Embodiment 1;

FIG. 4 is a figure for explaining the coordinate system of the ego vehicle, according to Embodiment 1;

FIG. 5 is a figure for explaining the example of the first relative positions and the second relative positions, according to Embodiment 1;

FIG. 6 is a figure for explaining the correction of the relative position and the calculation of the difference amount, according to Embodiment 1;

FIG. 7 is a figure for explaining the correction of the relative position and the calculation of the difference amount, when there is an evacuation space, according to Embodiment 1;

FIG. 8 is a figure for explaining the determination of the group of the plurality of difference amounts for the same object, according to Embodiment 1;

FIG. 9 is a figure for explaining the determination of the group of the plurality of difference amounts for the same object, according to Embodiment 1;

FIG. 10 is a figure for explaining the determination of the reliability, according to Embodiment 1;

FIG. 11 is a figure for explaining the determination of the reliability, according to Embodiment 1; and

FIG. 12 is a flowchart for explaining the processing of the position detection apparatus and the vehicle control apparatus, according to Embodiment 1.

### DETAILED DESCRIPTION OF THE EMBODIMENTS

### 1. Embodiment 1

A position detection apparatus 1 according to Embodiment 1 will be explained with reference to drawings. In the present embodiment, the position detection apparatus 1 is embedded into a vehicle control apparatus 30.

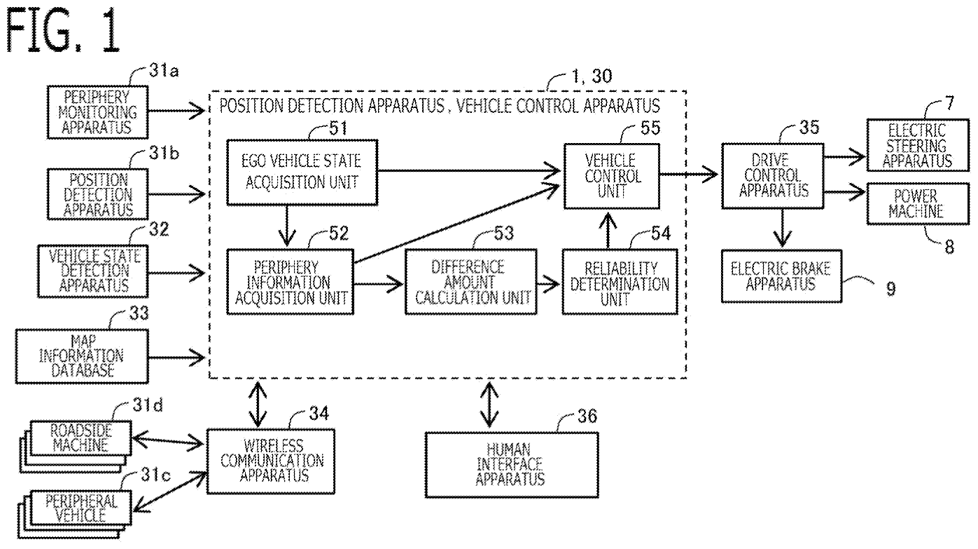

As shown in FIG. 1, an ego vehicle is provided with two or more periphery information detectors 31, a vehicle state detection apparatus 32, a map information database 33, a wireless communication apparatus 34, a vehicle control apparatus 30, a drive control apparatus 35, a power machine 8, an electric steering apparatus 7, an electric brake apparatus 9, a human interface apparatus 36, and the like.

As the periphery information detector 31, a periphery monitoring apparatus 31a which monitors around the ego vehicle, such as a radar and a camera, is provided. As the radar, a millimeter wave radar, a laser radar (LiDAR (Light Detection and Ranging)), an ultrasonic radar, and the like are used. In the present embodiment, plural kinds of periphery monitoring apparatuses 31a are provided.

As the periphery information detector 31, a position detection apparatus 31b which detects a current position of the ego vehicle (latitude, longitude, altitude) is provided. As the position detection apparatus 31b, a GNNS antenna which receives signal outputted from satellites such as GNSS (Global Navigation Satellite System), and the like is provided. For detection of the current position of the ego vehicle, various kinds of methods, such as the method using the traveling lane identification number of the ego vehicle, the map matching method, the dead reckoning method, and the method using the detection information around the ego vehicle, may be used together.

The wireless communication apparatus 34 performs a wireless communication with a base station and the like, using the wireless communication standard of cellular communication system, such as 4G and 5G. The wireless communication apparatus 34 communicates with a peripheral vehicle 31c which exists around the ego vehicle, a roadside machine 31d which monitors a road, and the like by the wireless communication, and acquires various kinds of information.

In the map information database 33, position and shape of the road and a ground object around the road are stored. For example, position and shape of each lane and road (for example, lane marking, road edge), position and shape of a roadside object provided in the roadside (for example, road shoulder, roadside wall, building wall, wall, guardrail, structure of median strip, lane segregation mark (rubber pole and the like), delineator, collision impact cushion (cushion drum and the like), pole, traffic signal, road sign, roadside tree, evacuation space), and the like are stored. In the map information database 33, various kinds of information, such as road information (number of lanes, road type, limit speed, and the like), are also stored. The map information database 33 is mainly constituted of a storage apparatus. The map information database 33 may be provided in a server outside the vehicle connected to the network, and the vehicle control apparatus 30 may acquire required road information from the server outside the vehicle via the wireless communication apparatus 34.

As the drive control apparatus 35, a power controller, a brake controller, an automatic steering controller, a light controller, and the like are provided. The power controller controls output of a power machine 8, such as an internal combustion engine and a motor. The brake controller controls brake operation of the electric brake apparatus 9. The automatic steering controller controls the electric steering apparatus 7. The light controller controls a direction indicator, a hazard lamp, and the like.

The vehicle condition detection apparatus 32 is a detection apparatus which detects an ego vehicle state which is a driving state and a traveling state of the ego vehicle. In the present embodiment, the vehicle state detection apparatus 32 detects a speed, an acceleration, a yaw rate, a steering angle, a lateral acceleration and the like of the ego vehicle, as the traveling state of the ego vehicle. For example, as the vehicle state detection apparatus 32, a speed sensor which detects a rotational speed of wheels, an acceleration sensor, an angular speed sensor, a steering angle sensor, and the like are provided.

As the driving state of the ego vehicle, an acceleration or deceleration operation, a steering angle operation, and a lane change operation by a driver are detected. For example, as the vehicle state detection apparatus 32, an accelerator position sensor, a brake position sensor, a steering angle sensor (handle angle sensor), a steering torque sensor, a direction indicator position switch, and the like are provided.

The human interface apparatus 36 is an apparatus which receives input of the driver or transmits information to the driver, such as a loudspeaker, a display screen, an input device, and the like.

### 1-1. Vehicle Control Apparatus 30

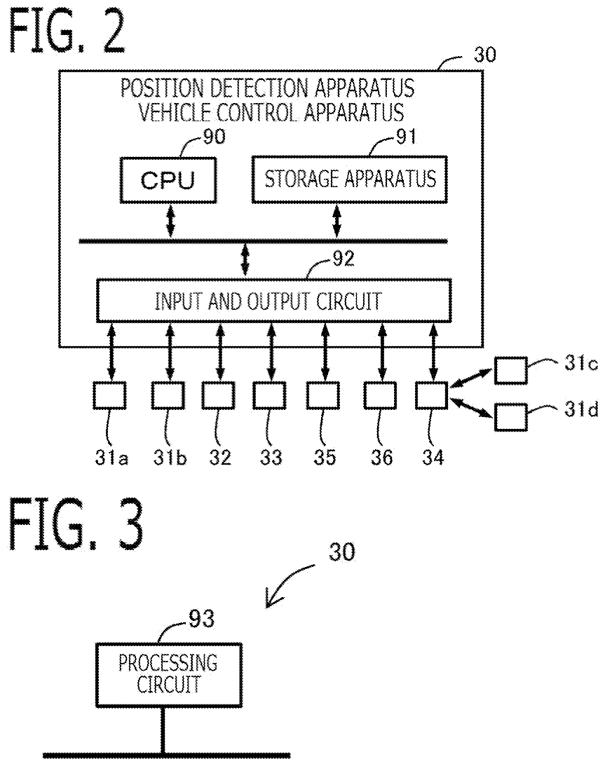

The vehicle control apparatus 30 is provided with functional units of an ego vehicle state acquisition unit 51, a periphery information acquisition unit 52, a difference amount calculation unit 53, a reliability determination unit 54, a vehicle control unit 55, and the like. Each function of the vehicle control apparatus 30 is realized by processing circuits provided in the vehicle control apparatus 30. As shown in FIG. 2, specifically, the vehicle control apparatus 30 is provided with an arithmetic processor 90 such as CPU (Central Processing Unit), storage apparatuses 91, an input and output circuit 92 which outputs and inputs external signals to the arithmetic processor 90, and the like.

As the arithmetic processor 90, ASIC (Application Specific Integrated Circuit), IC (Integrated Circuit), DSP (Digital Signal Processor), FPGA (Field Programmable Gate Array), GPU (Graphics Processing Unit), AI (Artificial Intelligence) chip, various kinds of logical circuits, various kinds of signal processing circuits, and the like may be provided. As the arithmetic processor 90, a plurality of the same type ones or the different type ones may be provided, and each processing may be shared and executed. As the storage apparatuses 91, various kinds of storage apparatuses, such as RAM (Random Access Memory), ROM (Read Only Memory), a flash memory, EEPROM (Electrically Erasable Programmable Read Only Memory), and a hard disk, are used.

The input and output circuit 92 is provided with a communication device, an A/D converter, an input/output port, a driving circuit, and the like. The input and output circuit 92 is connected to the periphery information detectors 31 (the periphery monitoring apparatus 31a, the position detection apparatus 31b), the vehicle state detection apparatus 32, the map information database 33, the wireless communication apparatus 34, the drive control apparatus 35, and the human interface apparatus 36, and communicates with these devices.

Then, the arithmetic processor 90 runs software items (programs) stored in the storage apparatus 91 and collaborates with other hardware devices in the vehicle control apparatus 30, such as the storage apparatus 91, and the input and output circuit 92, so that the respective functions of the functional units 51 to 55 provided in the vehicle control apparatus 30 are realized. Various kinds of setting data utilized in the functional units 51 to 55 are stored in the storage apparatus 91, such as EEPROM.

Alternatively, as shown in FIG. 3, the vehicle control apparatus 30 may be provided with a dedicated hardware 93 as the processing circuit, for example, a single circuit, a combined circuit, a programmed processor, a parallel programmed processor, ASIC, FPGA, GPU, AI chip, or a circuit which combined these. Each function of the vehicle control apparatus 30 will be described in detail below.

### 1-1-1. Ego Vehicle State Acquisition Unit 51

The ego vehicle state acquisition unit 51 acquires a traveling state of the ego vehicle. The ego vehicle state acquisition unit 51 acquires a position coordinate of the ego vehicle, a moving direction (an azimuth of moving direction), a speed, an acceleration, and the like, based on the position coordinate of the ego vehicle acquired from the position detection apparatus 31b, and the ego vehicle state acquired from the vehicle state detection apparatus 32.

### 1-1-2. Periphery Information Acquisition Unit 52

The periphery information acquisition unit 52 detects, for each of the plurality of periphery information detectors 31, relative positions RP of a plurality of object parts existing around the ego vehicle with respect to the ego vehicle, based on detection information of the periphery information detector 31.

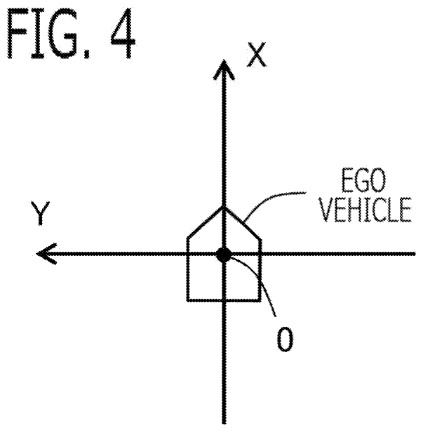

In the present embodiment, the relative position RP is calculated in an ego vehicle coordinate system. As shown in FIG. 4, the ego vehicle coordinate system is a coordinate system which has two axes of a longitudinal direction X and a lateral direction Y of the ego vehicle. The origin of the ego vehicle coordinate system is set at a representative position of the ego vehicle, such as a neutral steer point. The relative position RP may be calculated in a coordinate system which has two axes of a longitudinal direction X and a lateral direction Y of a traveling road of the ego vehicle.

<Detection of Relative Position RP of Peripheral Object by Position Detection Apparatus 31b>

The periphery information acquisition unit 52 detects the position coordinate of the ego vehicle, based on the detection information of the position detection apparatus 31b as the periphery information detector 31. In the present embodiment, as the position detection apparatus 31b, GNSS antenna and the like which receives GNSS (Global Navigation Satellite System) signals, such as GPS and QZSS, outputted from satellites is provided. The periphery information acquisition unit 52 detects the position coordinate of the ego vehicle, based on the GNSS signal received by the GNSS antenna. The position coordinate is a latitude, a longitude, an altitude, and the like. The periphery information acquisition unit 52 may update the position coordinate, based on the detection information of the vehicle state detection apparatus 32, when GNSS signal cannot be detected.

The periphery information acquisition unit 52 acquires the map information corresponding to the position coordinate of the ego vehicle from the map information database 33. In the present embodiment, the periphery information acquisition unit 52 acquires position coordinates of the plurality of object parts which exist around the ego vehicle, from the acquired map information. As mentioned above, for example, as the object which exists around the ego vehicle, the lane, the road, the roadside object, and the like are set. The periphery information acquisition unit 52 also acquires a position coordinate of each position of the lane and the roadside object which can be observed from the current position of the ego vehicle by the periphery monitoring apparatus 31a, such as the radar and the camera.

The periphery information acquisition unit 52 converts the position coordinate of each object part which exists around the ego vehicle acquired from the map information into the relative position with respect to the ego vehicle, based on the position coordinate of the ego vehicle, and the moving direction (the azimuth of moving direction). In the present embodiment, the relative position in the ego vehicle coordinate system is calculated.

<Detection of Relative Position of Peripheral Object by Periphery Monitoring Apparatus 31a>

The periphery information acquisition unit 52 detects the relative positions of the plurality of object parts existing around the ego vehicle with respect to the ego vehicle, based on the detection information of the periphery monitoring apparatus 31a as the periphery information detector 31.

A case where the millimeter wave radar is used as the periphery monitoring apparatus 31a will be explained. The millimeter wave radar irradiates a millimeter wave within a predetermined angle range around the ego vehicle, and receives a reflected wave reflected from the object. Then, the millimeter wave radar detects an incident angle of the reflected wave (an angle at which the object which reflected the millimeter wave exists), and a distance to the object part which reflected the millimeter wave, based on the received reflected wave. Various kinds of methods are used for the millimeter wave radar.

The periphery information acquisition unit 52 calculates a relative position of each object part with respect to the ego vehicle, based on a preliminarily set irradiation angle range of the millimeter wave on the basis of the ego vehicle, and the irradiation angle and the distance of each object part which were detected by the millimeter wave radar.

A case where LiDAR is used as the periphery monitoring apparatus 31a will be explained. LiDAR scans an irradiation angle of laser within a predetermined angle range, and receives a reflected light reflected from the object. Then, LiDAR detects a distance to the object part which reflected the laser at the irradiation angle, based on the received reflected light. Various kinds of methods are used for LiDAR.

The periphery information acquisition unit 52 calculates a relative position of each object part with respect to the ego vehicle, based on a preliminarily set irradiation angle range of the laser on the basis of the ego vehicle, and the irradiation angle and the distance of each object part which were detected by LiDAR.

A case where the camera is used as the periphery monitoring apparatus 31a will be explained. The periphery information acquisition unit 52 performs well-known image processing to a captured image of the camera, and detects a plurality of angles and distances of the object parts which are included in the image of the camera. A stereo camera is preferred, but a monocular camera may be used if distance can be detected.

The periphery information acquisition unit 52 calculates a relative position of each object part with respect to the ego vehicle, based on a preliminarily set captured angle range of the camera on the basis of the ego vehicle, and the angle and the distance of each object part which were detected by the image processing.

<Detection of Relative Position of Peripheral Object by Peripheral Vehicle 31c>

The periphery information acquisition unit 52 detects relative positions of a plurality of object parts existing around the ego vehicle with respect to the ego vehicle, based on detection information of the peripheral vehicle 31c as the periphery information detector 31. For example, the periphery information acquisition unit 52 acquires a position coordinate of the peripheral vehicle 31c, and position information on the plurality of object parts existing around the peripheral vehicle 31c detected by the peripheral vehicle 31c, from the peripheral vehicle 31c, via the wireless communication. Then, the periphery information acquisition unit 52 calculates relative positions of the peripheral vehicle 31c and the plurality of object parts existing around the peripheral vehicle 31c with respect to the ego vehicle, based on the position coordinate and the moving direction of the ego vehicle.

The periphery information acquisition unit 52 detects relative positions of the plurality of object parts existing around the ego vehicle with respect to the ego vehicle, based on detection information of the roadside machine 31d as the periphery information detector 31. The roadside machine 31d is provided on the roadside. The roadside machine 31d has a camera and the like which monitor a road state and the like, and detects position information on a plurality of object parts, such as a vehicle, a road, and a roadside object existing in a monitoring area. Then, the roadside machine 31d transmits the position information on the plurality of detected object parts to a vehicle existing around the roadside machine 31d via the wireless communication and the like.

The periphery information acquisition unit 52 acquires the position information (position coordinate and the like) on the plurality of object parts existing in the monitoring area of the roadside machine 31d detected by the roadside machine 31d, from the roadside machine 31d existing around the ego vehicle, via the wireless communication. Then, the periphery information acquisition unit 52 calculates relative positions of the plurality of object parts existing in the monitoring area of the roadside machine 31d with respect to the ego vehicle, based on the position coordinate and the moving direction of the ego vehicle.

### 1-1-3. Difference Amount Calculation Unit 53

The difference amount calculation unit 53 sets a first periphery information detector 311 and a second periphery information detector 312 to be determined, from the plurality of periphery information detectors 31. Then, the difference amount calculation unit 53 sets the relative positions of the plurality of object parts which were detected based on the detection information of the first periphery information detector 311, as a plurality of first relative positions RP1; and sets the relative positions of the plurality of object parts which were detected based on the detection information of the second periphery information detector 312, as a plurality of second relative positions RP2.

Then, the difference amount calculation unit 53 calculates a difference amount ΔRP between the first relative position RP1 and the second relative position RP2, for each of pairs of the first relative position RP1 and the second relative position RP2 in which relative positions correspond with each other.

The difference amount calculation unit 53 sets in order the first periphery information detector 311 and the second periphery information detector 312 to be determined, from the plurality of periphery information detectors 31; and the reliability determination unit 54 determines the reliability of the first relative positions RP1 and the second relative positions RP2 in order. For example, the difference amount calculation unit 53 selects, in order, any two arbitrary periphery information detectors 31 to be compared with each other, from the plurality of available periphery information detectors 31, such as the position detection apparatus 31b, the camera, the millimeter wave radar, LiDAR, the roadside machine 31d, and the peripheral vehicle 31c, and sets these as the first periphery information detector 311 and the second periphery information detector 312.

For example, when there are three periphery information detectors 31 of the position detection apparatus 31b, LiDAR, and the camera, the position detection apparatus 31b and LiDAR are set as the first and the second periphery information detectors 311, 312, and the reliability of the first relative positions RP1 by the position detection apparatus 31b and the second relative positions RP2 by LiDAR is determined. Next, LiDAR and the camera are set as the first and the second periphery information detectors 311, 312, the reliability of the first relative positions RP1 by LIDAR and the second relative positions RP2 by the camera is determined. Next, the camera and the position detection apparatus 31b are set as the first and the second periphery information detectors 311, 312, the reliability of the first relative positions RP1 by the camera and the second relative positions RP2 by the position detection apparatus 31b is determined.

### <Calculation of Difference Amount ΔRPy in Lateral Direction Y>

For the vehicle control, the detection accuracy of the relative position in the lateral direction Y of the ego vehicle or the traveling road of the ego vehicle becomes more important than the detection accuracy of the relative position in the longitudinal direction X. This is because an interval in the lateral direction Y between the vehicle and the peripheral object becomes narrower than an interval in the longitudinal direction X between the vehicle and the peripheral object, and the influence on the vehicle safety is large.

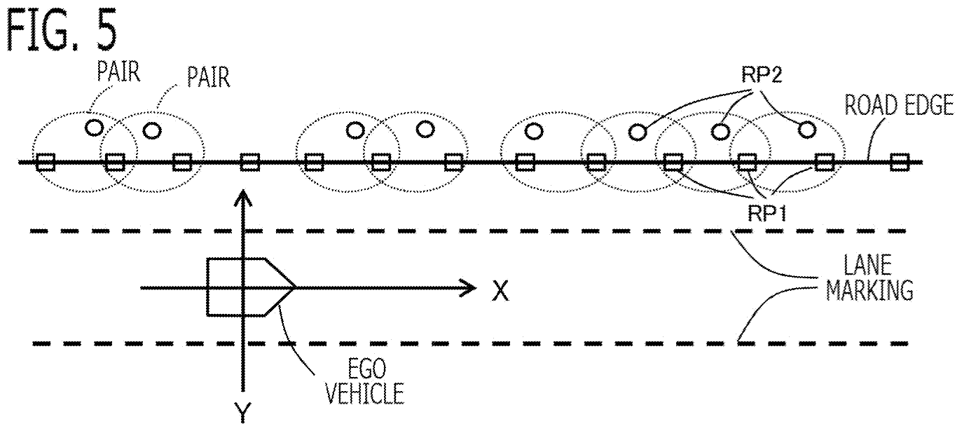

As shown in FIG. 5, the relative positions RP of the plurality of object parts detected by the detection information of each periphery information detector 31 becomes discrete relative positions. A resolution of intervals of the discrete relative positions RP varies depending on the method of each periphery information detector 31, and the object part whose relative position RP is detected varies irregularly.

Accordingly, in each pair of the first relative position RP1 and the second relative position RP2, the first relative position RP1x in the longitudinal direction X and the second relative position RP2x in the longitudinal direction X are shifted. Accordingly, if a difference amount ΔRPy between the first relative position RP1y and the second relative position RP2y in the lateral direction Y is simply calculated, the shift in the longitudinal direction X worsens the calculation accuracy.

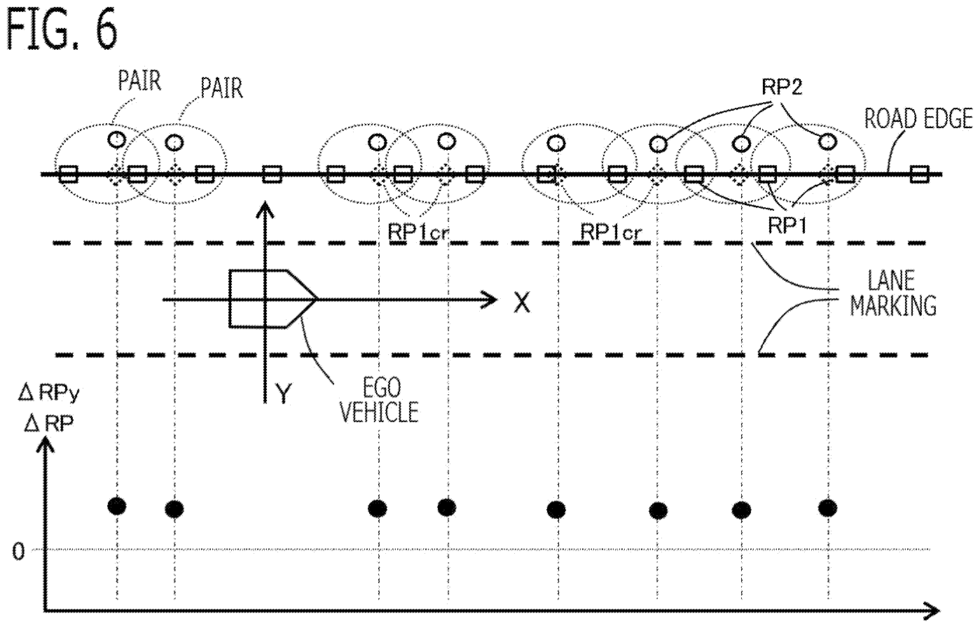

Then, in the present embodiment, as shown in FIG. 6, for each pair of the first relative position RP1 and the second relative position RP2 in which relative positions correspond with each other, the difference amount calculation unit 53 corrects one of the first relative position RP1 and the second relative position RP2 so that relative positions in the longitudinal direction X of the ego vehicle or the traveling road of the ego vehicle coincide with each other; and calculates a difference amount ΔRPy between the first relative position RP1y and the second relative position RP2y after correction in the lateral direction Y of the ego vehicle or the traveling road of the ego vehicle, as the difference amount ΔRP. In the example of FIG. 6, the difference amount ΔRP is calculated by subtracting the first relative position RP1y in the lateral direction Y from the second relative position RP2y in the lateral direction Y.

According to this configuration, even when the first relative position RP1x in the longitudinal direction X and the second relative position RP2x in the longitudinal direction X are shifted, deterioration of the calculation accuracy of the difference amount ΔRPy in the lateral direction Y due to the shift in the longitudinal direction X can be suppressed, and the calculation accuracy can be improved.

When defining one to be corrected among the first relative positions RP1 and the second relative positions RP2 as relative positions of a correction object, and defining one to be not corrected as relative positions of a non-correction object, the difference amount calculation unit 53 calculates an approximate line passing through the two relative positions of the correction object close to the relative position of the non-correction object; and calculates a relative position on the approximate line whose relative position in the longitudinal direction X coincide with a relative position of the non-correction object in the longitudinal direction X, as the relative position RPcr of the correction object after correction.

In this case, the one relative position of the non-correction object and the two relative positions of the correction object close to the relative position of the non-correction object becomes one pair of the first relative position RP1 and the second relative position RP2 in which the difference amount ΔRP is calculated.

According to this configuration, using the approximate line passing through the two relative positions of the correction object close to the relative position of the non-correction object, the relative position in the longitudinal direction X after correction of the correction object can be coincided with the relative position in the longitudinal direction X of the non-correction object, and the difference amount ΔRPy in the lateral direction can be calculated with good accuracy.

The difference amount calculation unit 53 sets one with larger detection number of relative positions among the first relative positions RP1 and the second relative positions RP2, as the relative positions of the correction object; and sets one with fewer detection number of relative positions, as the relative positions of the non-correction object.

According to this configuration, since the relative positions of the correction object are set to one with larger detection number of relative positions, the correction accuracy using the approximate line can be improved.

An example of correction processing is shown in FIG. 6. The first relative positions RP1 are relative positions of a plurality of parts of the road edge calculated using the position coordinate of the ego vehicle which was detected by the position detection apparatus 31b and the map information. The second relative positions RP2 are relative positions of a plurality of parts of the road edge detected by the millimeter wave radar or LiDAR as the periphery monitoring apparatus 31a.

As shown in FIG. 6, the detection number of the first relative positions RP1 by the position detection apparatus 31b is larger than the detection number of the second relative positions RP2 by the millimeter wave radar or LiDAR, the first relative positions RP1 are set as the relative positions of the correction object, and the second relative positions RP2 are set as the relative positions of the non-correction object.

The approximate line (in this example, a straight line) which passes through two first relative positions RP1 close to each second relative positions RP2 is calculated, a relative position on the approximate line whose relative position in the longitudinal direction X coincides with the second relative position RP2x in the longitudinal direction X is calculated as the first relative position RP1cr after correction. Since the approximate line coincides with the line of the road edge, it is not shown. Then, for each second relative position RP2, the difference amount ΔRPy between the second relative position RP2y and the first relative position RP1cry after correction in the lateral direction Y is calculated as the difference amount ΔRP. In this example, it is calculating by ΔRP=ΔRPy=RP2y-RP1cry.

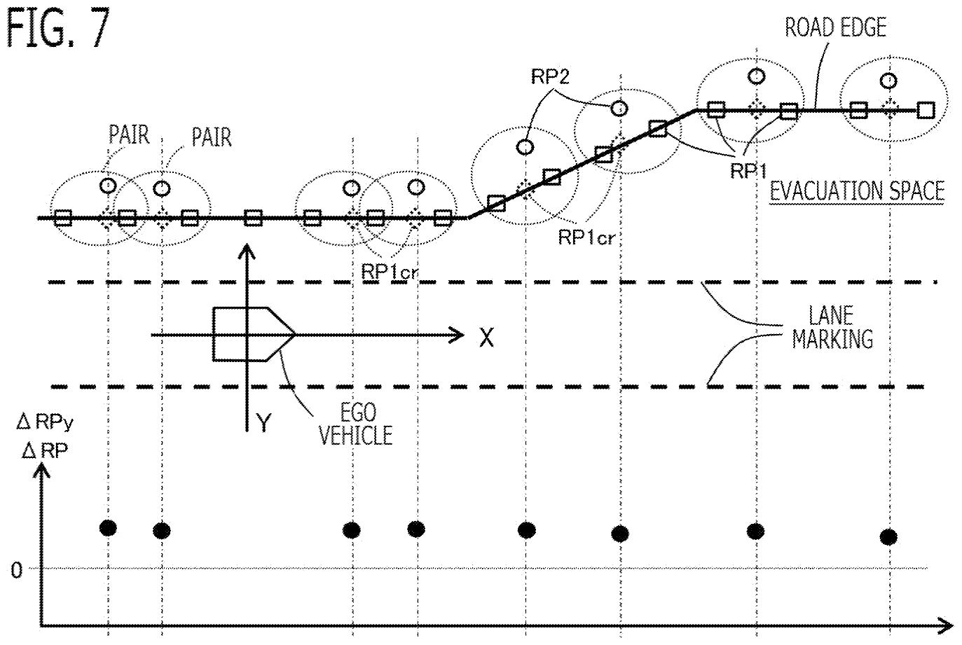

As shown in FIG. 7, in an evacuation space of road, an extending direction of the road edge is inclined with respect to the longitudinal direction X, a change of the relative position in the lateral direction Y becomes large with respect to a change of the relative position in the longitudinal direction X. Accordingly, if the first and the second relative positions before correction in which the relative positions in the longitudinal direction X are shifted with each other are compared, an error of the difference amount ΔRP becomes large. On the other hand, since the relative positions in the longitudinal direction X are coincided with each other in the first and the second relative positions after correction, the error of the difference amount ΔRP can be reduced.

### 1-1-4. Reliability Determination Unit 54

The reliability determination unit 54 determines a group of a plurality of the difference amounts ΔRP calculated for the same object, based on a plurality of the difference amounts ΔRP; and determines whether or not the reliability of the first relative positions RP1 and the second relative positions RP2 corresponding to the plurality of difference amounts ΔRP of the same object is high, based on the plurality of difference amounts ΔRP of the same object of one group which was determined to be calculated for the same object. The same object is paraphrased as the same kind of object or the like.

Since the difference amount ΔRP calculated for not same objects becomes large or its variation amount becomes large, if the reliability of the first and the second relative positions is determined using the difference amounts ΔRP of not same objects, it may be erroneously determined that the reliability is low. According to the above configuration, since the reliability is determined based on the plurality of difference amounts ΔRP to have been calculated for the same object, the reliability can be determined with good accuracy.

### <Determination of the Same Object>

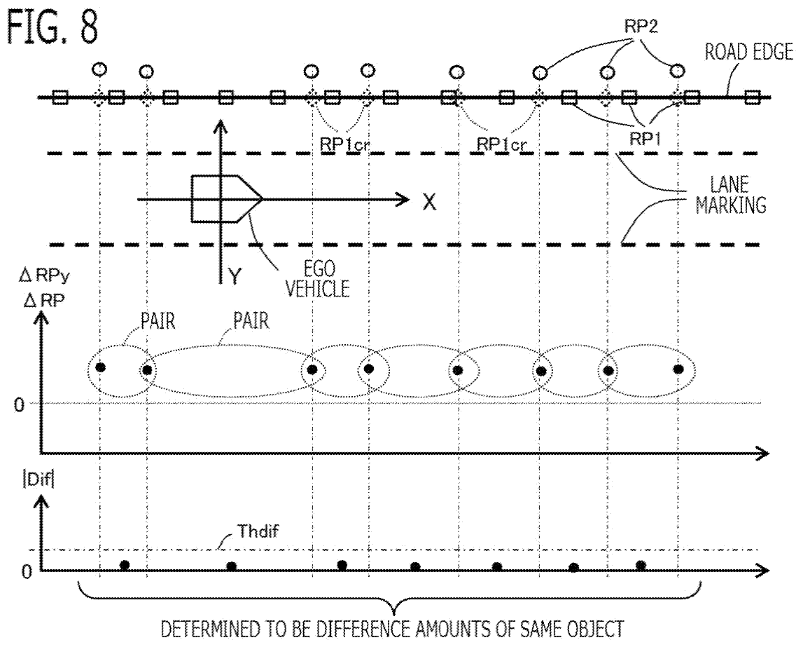

As shown in FIG. 8, when deviations Dif (in this example, absolute values of the deviations |Dif|) between a plurality of difference amounts whose relative positions are close with each other are less than or equal to a deviation determination value Thdif, the reliability determination unit 54 determines that the plurality of difference amounts ΔRP whose relative positions are close are the difference amounts ΔRP calculated for the same object.

According to this configuration, by comparing the plurality of difference amounts ΔRP whose relative positions are close with each other with each other, it can be determined whether or not these are calculated for the same object.

In the present embodiment, the reliability determination unit 54 continuously sets a pair of the two difference amounts ΔRP whose relative positions are close with each other from the plurality of difference amounts ΔRP, while overlapping relative positions between the pairs. For each of the pairs of the two difference amounts, when the absolute value | Dif| of the deviation between the two difference amounts ΔRP is less than or equal to the deviation determination value Thdif, the reliability determination unit 54 determines that the two difference amounts ΔRP are the difference amounts calculated for the same object; and determines the group of the plurality of difference amounts ΔRP calculated for the same object among the plurality of pairs of the two difference amounts ΔRP whose relative positions are overlapped continuously.

According to this configuration, by continuously setting the pair of the two difference amounts ΔRP whose relative position are close with each other, and comparing the two difference amounts ΔRP, it can be determined continuously whether or not these are calculated for the same object, and the group of the same object can be determined.

A determination example is shown in FIG. 8. Similarly to FIG. 6, the first relative positions RP1 are relative positions of a plurality of parts of the road edge which was detected by the position detection apparatus 31b. The second relative positions RP2 are relative positions of a plurality of parts of the road edge detected by the millimeter wave radar or LiDAR. In the example of FIG. 8, for all pairs of the two difference amounts ΔRP, the absolute value |Dif| of deviation between two difference amounts ΔRP is less than or equal to the deviation determination value Thdif, and it is determined that these are calculated for the same object. All of the plurality of difference amounts ΔRP shown in FIG. 8 are determined to be a group calculated for the same object.

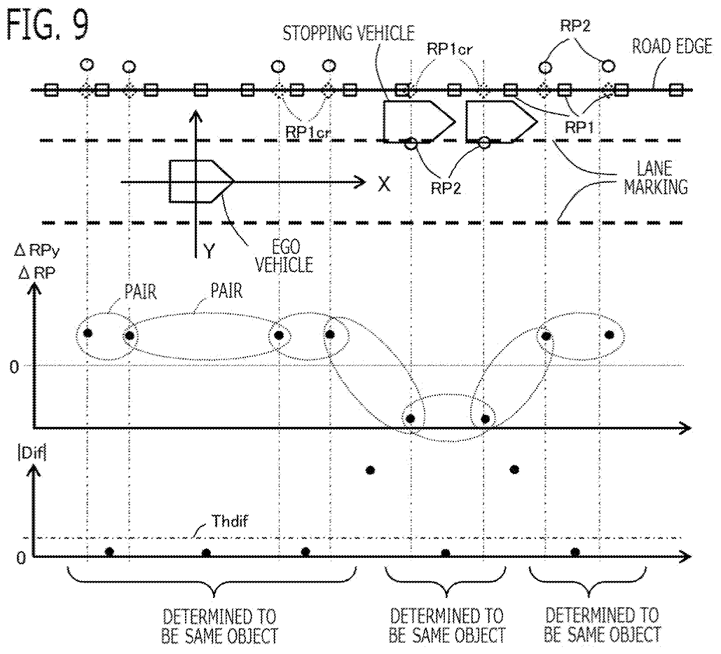

A different determination example is shown in FIG. 9. Unlike the example of FIG. 8, a plurality of vehicles stop on the road edge. Accordingly, since the first relative positions RP1 detected by the position detection apparatus 31b are positions of the map information, these become relative positions of the road edge in a state where there is no stopping vehicle. On the other hand, the second relative positions RP2 detected by the millimeter wave radar or LiDAR become relative positions of the stopping vehicle positioned before the road edge. Accordingly, the difference amounts ΔRP become large in the negative direction in the position of the stopping vehicle. Therefore, in the section of the road edge without the stopping vehicle, comparatively small difference amounts ΔRP are continued, and the absolute value |Dif| of deviation of two difference amounts ΔRP becomes less than or equal to the deviation determination value Thdif, and it is determined that these are calculated for the same object.

On the other hand, in the boundary between the road edge without the stopping vehicle and the road edge with the stopping vehicle, the difference amount ΔRP is varied, the absolute value |Dif| of deviation of two difference amounts ΔRP becomes larger than the deviation determination value Thdif, and it is determined that these are not calculated for the same object. In the section of the road edge with the stopping vehicle, the large difference amounts ΔRP in the negative direction are continued, the absolute value |Dif| of deviation of two difference amounts ΔRP becomes less than or equal to the deviation determination value Thdif, and it is determined that these are calculated for the same object. As the result, all of the plurality of difference amounts ΔRP corresponding to the continuous section of the road edge without the stopping vehicle are determined to be a group calculated for the same object. All of the plurality of difference amounts ΔRP corresponding to the continuous section of the road edge with the stopping vehicle are determined to be a group calculated for the same object, although these are actually the road edge and the stopping vehicle, and are not the same object.

### <Determination of Reliability>

As mentioned above, the reliability determination unit 54 determines whether or not the reliability of the first relative positions RP1 and the second relative positions RP2 corresponding to the plurality of difference amounts ΔRP of the same object is high, based on the plurality of difference amounts ΔRP of the same object.

In the present embodiment, the reliability determination unit 54 determines whether or not the reliability of the first relative positions RP1 and the second relative positions RP2 corresponding to the plurality of difference amounts ΔRP of the same object is high, based on a comparison result between the plurality of difference amounts ΔRP of the same object, and an acceptable range Ra.

The reliability determination unit 54 sets the acceptable range Ra, based on the plurality of difference amounts ΔRP of the same object.

Even though the difference amounts ΔRP are actually calculated for the same object and the reliability of the first and the second relative positions is high, the difference amounts ΔRP increase or decrease, and a variation degree of the difference amounts ΔRP increase or decrease, according to a kind of object, a difference in methods of the periphery information detectors 31, a detection condition, and the like. According to the above configuration, since the acceptable range Ra is set based on the plurality of difference amounts ΔRP of the same object, the acceptable range Ra can be set appropriately, according to a magnitude, a variation degree, and the like of the difference amounts ΔRP. Accordingly, based on the comparison result between the plurality of difference amounts ΔRP of the same object, and the acceptable range Ra, the reliability of corresponding the first and the second relative positions can be determined with good accuracy.

The reliability determination unit 54 calculates a variation degree of the plurality of difference amounts ΔRP of the same object, and sets the acceptable range Ra, based on the plurality of difference amounts ΔRP of the same object and the variation degree.

Based on magnitudes of the plurality of difference amounts ΔRP of the same object, the variation degree, and the like, the acceptable range Ra can be set appropriately, and the determination accuracy of reliability can be improved.

In the present embodiment, the reliability determination unit 54 sets an upper limit value RaH of the acceptable range and a lower limit value RaL of the acceptable range, as the acceptable range Ra.

In the present embodiment, as the variation degree, a standard deviation σ of the plurality of difference amounts ΔRP of the same object is used. For example, as shown in the next equation, the reliability determination unit 54 sets a value obtained by adding a value obtained by multiplying a coefficient K to the standard deviation σ, to an average value ΔRPave of the plurality of difference amounts ΔRP of the same object, as the upper limit value RaH of the acceptable range; and sets a value obtained by subtracting a value obtained by multiplying the coefficient K to the standard deviation σ, from the average value ΔRPave of the plurality of difference amounts ΔRP of the same object, as the lower limit value RaL of the acceptable range. For example, the coefficient K is set to three, but it may be set to a positive value other than three. As the variation degree, an index other than the standard deviation σ may be used.

$$RaH = Δ RPave + K \times σ \qquad ( 1 )$$

$$RaL = Δ RPave - K \times σ$$

An absolute value of difference amount ΔRP may be used for determination. Also in this case, an average value of the absolute values of the plurality of difference amounts ΔRP of the same object is used as the average value ΔRPave. A standard deviation of the absolute values of the plurality of difference amounts ΔRP of the same object is used as the standard deviation σ. In this case, the lower limit value RaL of the acceptable range may be set to zero, and only the upper limit value RaH of the acceptable range may be set.

The reliability determination unit 54 determines whether or not each of the plurality of difference amounts ΔRP of the same object is within the acceptable range Ra from the upper limit value RaH to the lower limit value RaL. Then, the reliability determination unit 54 determines whether or not the reliability of the first relative positions and the second relative positions corresponding to the plurality of difference amounts of the same object is high, based on a ratio RN (=Nin/Nall) of a number Nin of the difference amounts which became within the acceptable range Ra with respect to a total number Nall of the plurality of difference amounts of the same object. For example, the reliability determination unit 54 determines that the reliability is high, when the ratio RN is greater than or equal to a ratio threshold value; and determines that the reliability is low, when the ratio RN is less than the ratio threshold value.

According to this configuration, by considering a variation in the difference amounts ΔRP, the reliability can be determined stochastically.

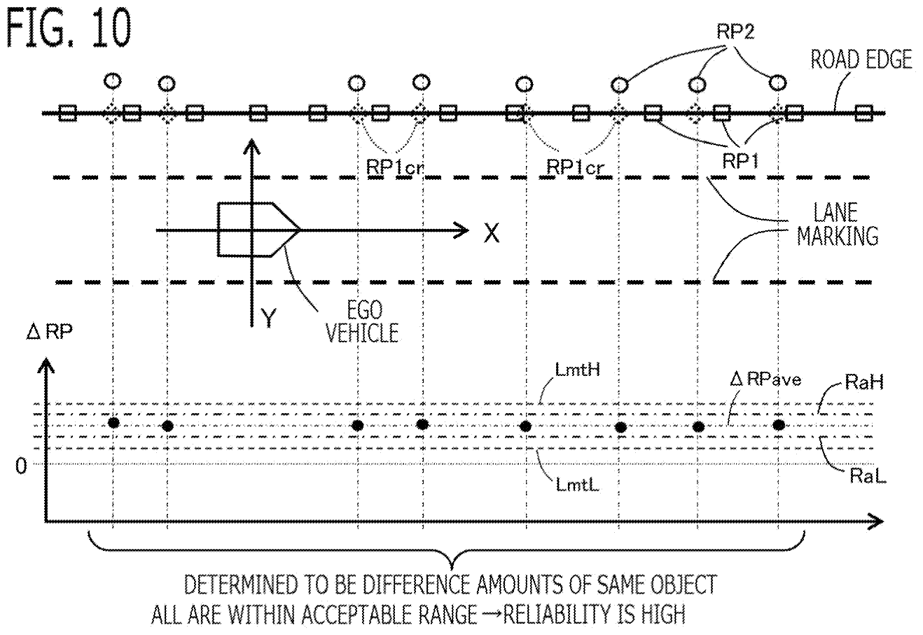

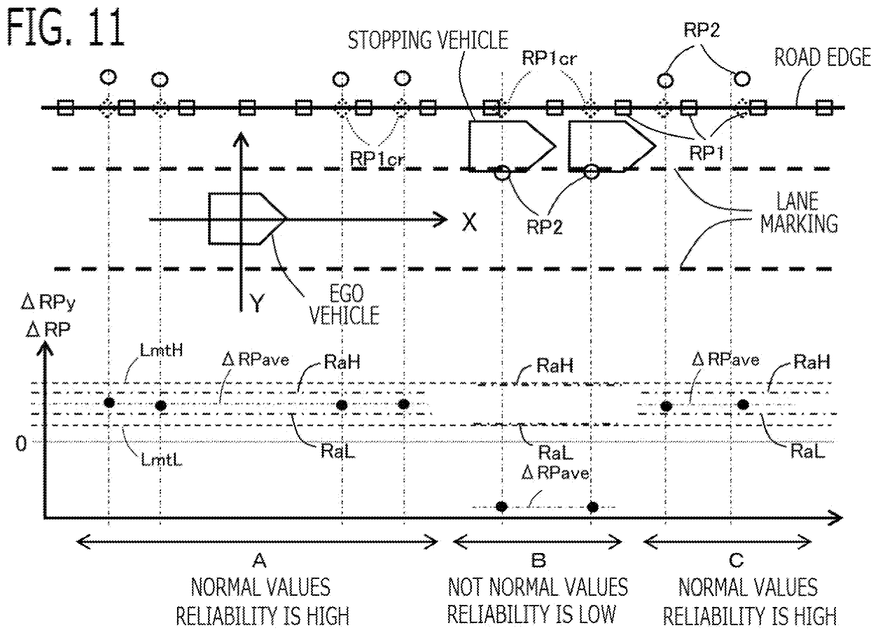

In an example of FIG. 10 corresponding to FIG. 6 and FIG. 8, since all of the plurality of difference amounts ΔRP of the same object is within the acceptable range Ra from the upper limit value RaH of the acceptable range to the lower limit value RaL of the acceptable range, the ratio RN becomes 100%, and it is determined that the reliability is high.

The reliability determination unit 54 upper and lower limits the acceptable range Ra by an upper limitation value LmtH and a lower limitation value LmtL.

For example, when the upper limit value RaH of the acceptable range becomes larger than the upper limitation value LmtH, the reliability determination unit 54 sets the upper limitation value LmtH as the upper limit value RaH of the acceptable range after limitation. When the lower limit value RaL of the acceptable range becomes smaller than the lower limitation value LmtL, the reliability determination unit 54 sets the lower limitation value LmtL as the lower limit value RaL of the acceptable range after limitation.

Alternatively, the reliability determination unit 54 may upper and lower limit individually a center value of the upper limit value RaH of the acceptable range and the lower limit value RaL of the acceptable range (in this example, an average value ΔRPave), and a width of the upper limit value RaH of the acceptable range and the lower limit value RaL of the acceptable range (in this example, 2×K×σ).

In the present embodiment, the reliability determination unit 54 sets the upper limitation value LmtH and the lower limitation value LmtL, based on detection characteristic of the first relative positions RP1 by the first periphery information detector 311, and detection characteristic of the second relative positions RP2 by the second periphery information detector 312.

As shown in the example of FIG. 10, the first relative positions RP1 of the left side road edge of the map information by the position detection apparatus 31b are relative positions of a curb. If the second relative positions RP2 detected by the millimeter wave radar or LiDAR are relative positions of a roadside wall or a guardrail positioned on the left side of the curb, the second relative positions RP2y in the lateral direction Y become larger than the first relative positions RP1y in the lateral direction Y in an offset manner, and the difference amounts ΔRP obtained by subtracting the first relative positions RP1y in the lateral direction Y from the second relative positions RP2y in the lateral direction Y become larger than zero in an offset manner. In this detection characteristic, the upper limitation value LmtH and the lower limitation value LmtL may be offset in the positive direction. Conversely, the upper limitation value LmtH and the lower limitation value LmtL for the right side road edge may be offset in the negative direction.

As a different example, when the relative positions of a lane marking, such as a white line, detected by the camera, and the relative positions of a lane marking, such as a white line, of the map information by the position detection apparatus 31b are mutually compared, the upper limitation value LmtH and the lower limitation value LmtL may not be offset, and may be set centering on zero.

For example, the reliability determination unit 54 sets the upper limitation value LmtH and the lower limitation value LmtL, based on a kind of the first periphery information detector 311, a kind of the second periphery information detector 312, a positional relationship of the object part with respect to the ego vehicle, and at least one of a kind of the object part where the first relative position RP1 was detected and a kind of the object part where the second relative position RP2 was detected. By these information, the detection characteristic of each relative position by each periphery information detector can be determined, an offset direction and an offset amount of the upper limitation value LmtH and the lower limitation value LmtL can be determined.

The reliability determination unit 54 determines whether or not the plurality of difference amounts ΔRP of the same object are normal values as the difference amounts ΔRP of the same object; and sets the acceptable range Ra to a preliminarily set specified range, when determining that these are not normal values.

For example, the reliability determination unit 54 determines whether or not the plurality of difference amounts ΔRP of the same object exceeds the specified range; determines that the plurality of difference amounts ΔRP of the same object are not normal values as the plurality of difference amount ΔRP of the same object, when a ratio of difference amounts ΔRP exceeding the specified range is greater than or equal to a determination value; and determines that the plurality of difference amounts ΔRP of the same object are normal values as the plurality of difference amount ΔRP of the same object, when the ratio of the difference amounts ΔRP exceeding the specified range is less than the determination value. For example, the specified range is set to a range from the upper limitation value LmtH to the lower limitation value LmtL. Then, when determining that these are not normal values, the reliability determination unit 54 sets the specified range (in this example, the upper limitation value LmtH and the lower limitation value LmtL), as the upper limit value RaH of the acceptable range, and the lower limit value RaL of the acceptable range. The upper limitation value LmtH and the lower limitation value LmtL in this case may be set based on each detection characteristic of relative positions by each periphery information detector, as described above.

In this way, by setting the acceptable range Ra to the preliminarily set specified range when determining that these are not normal values as the plurality of difference amounts ΔRP of the same object, the reliability of relative positions can be determined with good accuracy.

In an example of FIG. 11 corresponding to FIG. 9, in the section A without the stopping vehicle, the plurality of difference amounts ΔRP of the same object are determined to be normal values as the plurality of difference amounts ΔRP of the same object; and the upper limit value RaH of the acceptable range and the lower limit value RaL of the acceptable range are set based on the plurality of difference amounts ΔRP of the same object. Then, in the section A, since the ratio of difference amounts ΔRP which are within the acceptable range Ra from the upper limit value RaH of the acceptable range to the lower limit value RaL of the acceptable range is greater than or equal to a ratio threshold value, it is determined that the reliability of the first relative positions RP1 and the second relative positions RP2 in the section A is high. Since the section C without the stopping vehicle is similar to the section A, it is similarly determined that the reliability is high.

On the other hand, in the section B with the stopping vehicle, the plurality of difference amounts ΔRP of the same object are determined to be not normal values as the plurality of difference amounts ΔRP of the same object; and the upper limitation value LmtH and the lower limitation value LmtL are set as the upper limit value RaH of the acceptable range, and the lower limit value RaL of the acceptable range. Then, in the section B, since the ratio of difference amounts ΔRP which are within the acceptable range Ra from the upper limit value RaH of the acceptable range to the lower limit value RaL of the acceptable range is less than the ratio threshold value, it is determined that the reliability of the first relative positions RP1 and the second relative positions RP2 in the section B is low.

The reliability determination unit 54 may correct the acceptable range of present calculation Ra_new which is the acceptable range set based on the plurality of difference amounts ΔRP of the same object calculated in the present calculation cycle, by the acceptable range Ra_old calculated in the past calculation cycle for this same object (referred to as the acceptable range of past calculation Ra_old), and may calculate final acceptable range Ra. The acceptable range of present calculation Ra_new is the acceptable range Ra calculated by the equation (1) and the like.

If the acceptable range of present calculation Ra_new changes suddenly from the acceptable range of past calculation Ra_old by noise component and the like, the determination accuracy of reliability may be deteriorated. According to the above configuration, even if the acceptable range of present calculation Ra_new changes suddenly, the acceptable range of present calculation Ra_new is corrected by the acceptable range of past calculation Ra_old, and the final acceptable range Ra is calculated, thus the setting accuracy of final acceptable range Ra can be improved.

The reliability determination unit 54 corrects the acceptable range of present calculation Ra_new so as to suppress a change of the final acceptable range Ra of the same object from the acceptable range of the past calculation Ra_old calculated in the past calculation cycle for the same object, and calculates the final acceptable range Ra.

For example, the reliability determination unit 54 performs a smoothing processing to the plurality of acceptable ranges Ra_new, Ra_old which were calculated in the present calculation cycle and the plurality of past calculation cycles, and calculates the final acceptable range Ra. As the smoothing processing, a first-order-lag filter processing, a moving average processing, or a weighted average processing is performed, for example. If the weighted average processing is performed, weights of the present calculation cycle and the past calculation cycles close to the present calculation cycle may be increased.

If the upper limit value RaH of the acceptable range and the lower limit value RaL of the acceptable range are calculated as the acceptable range Ra, the upper limit value RaH_new and the lower limit value RaL_new of the acceptable range of present calculation may be corrected by the upper limit value RaH_old and the lower limit value RaL_old of the acceptable range of past calculation, respectively. If smoothing processing is performed, the smoothing processing is performed to each of the upper limit values RaH_new, RaH_old and the lower limit values RaL_new, RaL_old which were calculated in the present calculation cycle and the plurality of past calculation cycles, and the upper limit value RaH and the lower limit value RaL of the final acceptable range may be calculated.

Whether or not the acceptable range Ra_new calculated in the present calculation cycle and the acceptable ranges Ra_old calculated in the plurality of past calculation cycles are calculated for the same object is determined based on a correspondence relation between a moving amount of the ego vehicle during each calculation cycle, and the first and the second relative positions which were used for the calculation of the acceptable range Ra_new, Ra_old in each calculation cycle.

### 1-1-5. Vehicle Control Unit 55

The vehicle control unit 55 controls a traveling of vehicle using the first relative positions RP1 and the second relative positions RP2 which were determined that the reliability is high.

If there are three or more periphery information detectors 31, and the plurality of combinations of the first periphery information detector 311 and the second periphery information detector 312 is set from the three or more periphery information detectors 31, the vehicle control unit 55 controls the traveling of vehicle using the first relative positions RP1 and the second relative positions RP2 which were determined that the reliability is high in any combination.

For example, if there are the three periphery information detectors 31 of the position detection apparatus 31b, LiDAR, and the camera, a combination of the position detection apparatus 31b and LiDAR, a combination of LiDAR and the camera, and a combination of the camera and the position detection apparatus 31b are set in order as the first and the second periphery information detectors 311, 312; and the reliability of the first and the second relative positions RP1, RP2 is determined. For example, as in the examples of the figures mentioned above, in the section with the stopping vehicle, even if it is determined that the reliability of the relative positions by the position detection apparatus 31b and the relative positions by LiDAR is low, if it is determined that the reliability of the relative positions by LiDAR and the relative positions by the camera is high, the traveling of vehicle may be controlled using the relative positions by LiDAR, and the relative positions by the camera.

Alternatively, when there is no combination determined that the reliability is high, the vehicle control unit 55 may not use the relative positions by the position detection apparatus 31b using the map information with low real time property in order to prioritize safety; and may control the traveling of vehicle using the relative positions by the periphery monitoring apparatus 31a with high real time property, such as the millimeter wave radar, LiDAR, and the camera.

When performing an automatic driving, the vehicle control unit 55 determines a target traveling trajectory adjusted with the first relative positions RP1 or the second relative positions RP2 which were determined that the reliability is high. In this case, the peripheral vehicle 31c, the obstacle, the pedestrian, and the road shape which were acquired by the periphery monitoring apparatus 31a are considered. The target traveling trajectory is a time series traveling plan of the position of the ego vehicle, the traveling direction of the ego vehicle, the speed of the ego vehicle, the driving lane, the position where lane is changed, and the like at each future time.

The vehicle control unit 55 controls the vehicle so as to follow the target traveling trajectory of the ego vehicle. For example, the vehicle control unit 55 decides a target speed, a target steering angle, an operation command of the direction indicator, and the like; and transmits each decided command value to the drive control apparatus 35, such as the power controller, the brake controller, the automatic steering controller, and the light controller.

The power controller controls output of the power machine 8, such as the internal combustion engine and the motor, so that the speed of the ego vehicle follows the target speed. The brake controller controls the brake operation of the electric brake apparatus 9 so that the speed of the ego vehicle follows the target speed. The automatic steering controller controls the electric steering apparatus 7 so that the steering angle follows the target steering angle. The light controller controls the direction indicator according to the operation command of the direction indicator.

Alternatively, when performing a driving assistance of the driver, the vehicle control unit 55 transmits commands for performing the driving assistance of the driver to any one or more of the power controller, the brake controller, and the automatic steering controller, based on the first relative positions RP1 or the second relative positions RP2 which were determined that the reliability is high; and controls any one or more of the output of the power machine 8, the brake operation of the electric brake apparatus 9, and the steering operation of the electric steering apparatus 7. For example, as the control of vehicle, a lane keeping control, an obstacle avoidance control, a lane change control, a cruise control, a vehicle distance control, a preceding vehicle tracking control, and the like are performed.

Alternatively, when performing a manual driving by the driver, the vehicle control unit 55 informs various kinds of guidance for driving to the driver via the human interface apparatus 36, based on the first relative positions RP1 or the second relative positions RP2 which were determined that the reliability is high. For example, as various kinds of guidance, a route guide, a guidance of around information, a guidance of contact danger, and the like are performed.

### <Flowchart>

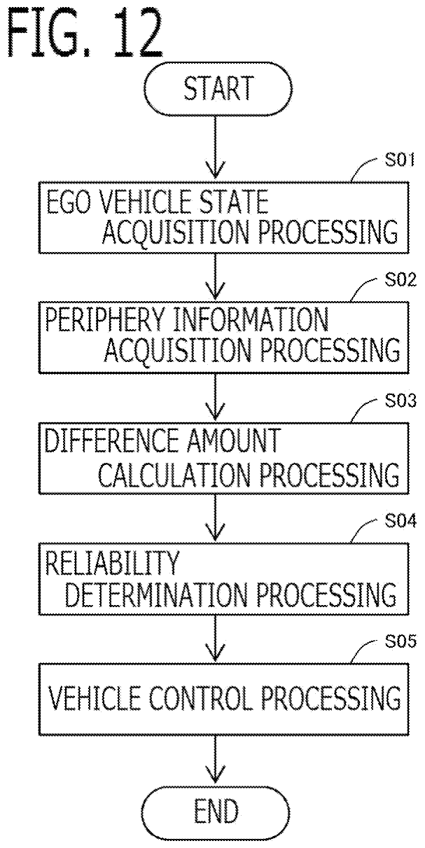

FIG. 12 is a schematic flowchart explaining a processing of the position detection apparatus 1 and the vehicle control apparatus 30 (a position detection method and a vehicle control method) according to the present embodiment. The processing of FIG. 12 is performed for every predetermined calculation cycle, for example, by the arithmetic processor 90 performing software (program) stored in the storage apparatus 91.

In the step S01, as mentioned above, the ego vehicle state acquisition unit 51 performs an ego vehicle state acquisition processing of acquiring a traveling state of the ego vehicle. The ego vehicle state acquisition unit 51 acquires a position coordinate of the ego vehicle, a moving direction, a speed, an acceleration, and the like, based on the position coordinate of the ego vehicle acquired from the position detection apparatus 31b, and the ego vehicle state acquired from the vehicle state detection apparatus 32.

In the step S02, as mentioned above, the periphery information acquisition unit 52 performs a periphery information acquisition processing of detecting, for each of the plurality of periphery information detectors 31, relative positions RP of a plurality of object parts existing around the ego vehicle with respect to the ego vehicle, based on detection information of the periphery information detector 31.

In the step S03, as mentioned above, the difference amount calculation unit 53 performs a difference amount calculation processing. Specifically, the difference amount calculation unit 53 sets a first periphery information detector 311 and a second periphery information detector 312 to be determined, from the plurality of periphery information detectors 31. The difference amount calculation unit 53 sets the relative positions of the plurality of object parts which were detected based on the detection information of the first periphery information detector 311, as a plurality of first relative positions RP1; and sets the relative positions of the plurality of object parts which were detected based on the detection information of the second periphery information detector 312, as a plurality of second relative positions RP2. Then, the difference amount calculation unit 53 calculates a difference amount ΔRP between the first relative position RP1 and the second relative position RP2, for each of pairs of the first relative position RP1 and the second relative position RP2 in which relative positions correspond with each other.

In the step S04, as mentioned above, the reliability determination unit 54 performs a reliability determination processing of determining a group of a plurality of the difference amounts ΔRP calculated for the same object, based on a plurality of the difference amounts ΔRP; and determining whether or not the reliability of the first relative positions RP1 and the second relative positions RP2 corresponding to the plurality of difference amounts ΔRP of the same object is high, based on the plurality of difference amounts ΔRP of the same object of one group which was determined to be calculated for the same object.

In the step S05, as mentioned above, the vehicle control unit 55 performs a vehicle control processing of controlling a traveling of vehicle using the first relative positions RP1 and the second relative positions RP2 which were determined that the reliability is high.

### <Summary of Aspects of the Present Disclosure>

Hereinafter, the aspects of the present disclosure is summarized as appendixes.

### APPENDIX 1

A position detection apparatus comprising:
a periphery information acquisition unit that detects, for each of a plurality of periphery information detectors, relative positions of a plurality of object parts existing around an ego vehicle with respect to the ego vehicle, based on detection information of the periphery information detector;
a difference amount calculation unit that sets a first periphery information detector and a second periphery information detector to be determined, from the plurality of periphery information detectors; sets the relative positions of the plurality of object parts which were detected based on the detection information of the first periphery information detector, as a plurality of first relative positions; sets the relative positions of the plurality of object parts which were detected based on the detection information of the second periphery information detector, as a plurality of second relative positions; and calculates a difference amount between the first relative position and the second relative position, for each of pairs of the first relative position and the second relative position in which relative positions correspond with each other; and
a reliability determination unit that determines a group of a plurality of the difference amounts calculated for the same object, based on a plurality of the difference amounts, and determines whether or not a reliability of the first relative positions and the second relative positions corresponding to the plurality of difference amounts of the same object is high, based on the plurality of difference amounts of the same object of one group which was determined to be calculated for the same object.

### APPENDIX 2

The position detection apparatus according to appendix 1,
wherein the difference amount calculation unit, for each of the pairs of the first relative position and the second relative position in which relative positions correspond with each other, corrects one of the first relative position and the second relative position so that relative positions in a longitudinal direction of the ego vehicle or a traveling road of the ego vehicle coincide with each other; and calculates a difference amount between the first relative position and the second relative position after correction in a lateral direction of the ego vehicle or the traveling road of the ego vehicle, as the difference amount.

### APPENDIX 3

The position detection apparatus according to appendix 2,
wherein, when defining one to be corrected among the first relative positions and the second relative positions as relative positions of a correction object and defining one to be not corrected as relative positions of a non-correction object, the difference amount calculation unit calculates an approximate line passing through the two relative positions of the correction object close to the relative position of the non-correction object; and calculates a relative position on the approximate line whose relative position in the longitudinal direction coincide with a relative position of the non-correction object in the longitudinal direction, as the relative position of the correction object after correction.

### APPENDIX 4

The position detection apparatus according to appendix 3,
wherein the difference amount calculation unit sets one with larger detection number of relative positions among the first relative positions and the second relative positions as the relative positions of the correction object, and sets one with smaller detection number of relative positions as the relative positions of the non-correction object.

### APPENDIX 5

The position detection apparatus according to any one of appendixes 1 to 4,
wherein, when deviations between a plurality of difference amounts whose relative positions are close with each other are less than or equal to a deviation determination value, the reliability determination unit determines that the plurality of difference amounts whose relative positions are close are the difference amounts calculated for the same object.

### APPENDIX 6

The position detection apparatus according to any one of appendixes 1 to 4,
wherein the reliability determination unit continuously sets a pair of the two difference amounts whose relative positions are close with each other from the plurality of difference amounts, while overlapping relative positions between the pairs; for each of the pairs of the two difference amounts, when a deviation between the two difference amounts is less than or equal to a deviation determination value, determines that the two difference amounts are the difference amounts calculated for the same object; and determines the group of the plurality of difference amounts calculated for the same object among the plurality of pairs of the two difference amounts whose relative positions are overlapped continuously.

### APPENDIX 7

The position detection apparatus according to any one of appendixes 1 to 6,
wherein the reliability determination unit sets an acceptable range, based on the plurality of difference amounts of the same object; and determines whether or not the reliability of the first relative positions and the second relative positions corresponding to the plurality of difference amounts of the same object is high, based on a comparison result between the plurality of difference amounts of the same object, and the acceptable range.

### APPENDIX 8

The position detection apparatus according to appendix 7,
wherein the reliability determination unit calculates a variation degree of the plurality of difference amounts of the same object; and sets the acceptable range, based on the plurality of difference amounts of the same object and the variation degree.

### APPENDIX 9

The position detection apparatus according to appendix 7 or 8,
wherein the reliability determination unit sets an upper limitation value and a lower limitation value, based on a detection characteristic of the first relative position by the first periphery information detector, and a detection characteristic of the second relative position by the second periphery information detector; and upper and lower limits the acceptable range with the upper limitation value and the lower limitation value.

### APPENDIX 10

The position detection apparatus according to any one of appendixes 7 to 9,
wherein the reliability determination unit determines whether or not the plurality of difference amounts of the same object are normal values as the difference amounts of the same object; and sets the acceptable range to a preliminarily set specified range, when determining to be not normal values.

### APPENDIX 11

The position detection apparatus according to any one of appendixes 7 to 10,
wherein the reliability determination unit calculates the final acceptable range by correcting the acceptable range of present calculation which is the acceptable range set based on the plurality of difference amounts of the same object calculated in a present calculation cycle, by the acceptable range calculated in a past calculation cycle for this same object.

### APPENDIX 12

The position detection apparatus according to appendix 11,
wherein the reliability determination unit calculates the final acceptable range by correcting the acceptable range of present calculation so as to suppress a change in the final acceptable range of the same object from the acceptable range calculated in the past calculation cycle for the same object.

### APPENDIX 13

The position detection apparatus according to any one of appendixes 1 to 12,
wherein the reliability determination unit determines whether or not the reliability of the first relative positions and the second relative positions corresponding to the plurality of difference amounts of the same object is high, based on a ratio of a number of the difference amounts which became within the acceptable range, with respect to a total number of the plurality of difference amounts of the same object.

### APPENDIX 14

The position detection apparatus according to any one of appendixes 1 to 13,
wherein the plurality of periphery information detectors include any two or more of a position detection apparatus which detects a current position of the ego vehicle, one or more kinds of periphery monitoring apparatuses which monitor around the ego vehicle, a roadside machine which monitors a road, and a peripheral vehicle which exists around the ego vehicle.

### APPENDIX 15

The position detection apparatus according to any one of appendixes 1 to 14, further comprising
a vehicle control unit that controls a traveling of vehicle using the first relative positions and the second relative positions which were determined that the reliability is high.

### APPENDIX 16

The position detection apparatus according to appendix 15,
wherein three or more the periphery information detectors are provided,
wherein the difference amount calculation unit sets a plurality of combinations of the first periphery information detector and the second periphery information detector from the three or more periphery information detectors; and calculates a plurality of the difference amounts for the each combination,
wherein the reliability determination unit, for the each combination, determines whether or not the reliability of the first relative positions and the second relative positions corresponding to the plurality of difference amounts of the same object is high, based on the plurality of difference amounts, and
wherein the vehicle control unit controls the traveling of vehicle using the first relative positions and the second relative positions which were determined that the reliability is high in any combination.

### APPENDIX 17

A position detection method that makes an arithmetic processor perform each following step, comprising:
a periphery information acquisition step of detecting, for each of a plurality of periphery information detectors, relative positions of a plurality of object parts existing around an ego vehicle with respect to the ego vehicle, based on detection information of the periphery information detector;
a difference amount calculation step of setting a first periphery information detector and a second periphery information detector to be determined, from the plurality of periphery information detectors; setting the relative positions of the plurality of object parts which were detected based on the detection information of the first periphery information detector, as a plurality of first relative positions; setting the relative positions of the plurality of object parts which were detected based on the detection information of the second periphery information detector, as a plurality of second relative positions; and calculating a difference amount between the first relative position and the second relative position, for each of pairs of the first relative position and the second relative position in which relative positions correspond with each other;
a reliability determination step of determining a group of a plurality of the difference amounts calculated for the same object, based on a plurality of the difference amounts, and determining whether or not the reliability of the first relative positions and the second relative positions corresponding to the plurality of difference amounts of the same object is high, based on the plurality of difference amounts of the same object of one group which was determined to be calculated for the same object.

Although the present disclosure is described above in terms of an exemplary embodiment, it should be understood that the various features, aspects and functionality described in the embodiment are not limited in their applicability to the particular embodiment with which they are described, but instead can be applied, alone or in various combinations to the embodiment. It is therefore understood that numerous modifications which have not been exemplified can be devised without departing from the scope of the present disclosure. For example, at least one of the constituent components may be modified, added, or eliminated.

What is claimed is:

1. A position detection apparatus comprising at least one processor configured to implement:
a periphery information acquisitor that detects, for each of a plurality of periphery information detectors, relative positions of a plurality of object parts existing around an ego vehicle with respect to the ego vehicle, based on detection information of the periphery information detector;
a difference amount calculator that sets a first periphery information detector and a second periphery information detector to be determined, from the plurality of periphery information detectors; sets the relative positions of the plurality of object parts which were detected based on the detection information of the first periphery information detector, as a plurality of first relative positions; sets the relative positions of the plurality of object parts which were detected based on the detection information of the second periphery information detector, as a plurality of second relative positions; and calculates a difference amount between the first relative position and the second relative position, for each of pairs of the first relative position and the second relative position in which relative positions correspond with each other; and
a reliability determiner that determines a group of a plurality of the difference amounts calculated for the same object, based on a plurality of the difference amounts, and determines whether or not a reliability of the first relative positions and the second relative positions corresponding to the plurality of difference amounts of the same object is high, based on the plurality of difference amounts of the same object of one group which was determined to be calculated for the same object.

2. The position detection apparatus according to claim 1,
wherein the difference amount calculator, for each of the pairs of the first relative position and the second relative position in which relative positions correspond with each other, corrects one of the first relative position and the second relative position so that relative positions in a longitudinal direction of the ego vehicle or a traveling road of the ego vehicle coincide with each other; and calculates a difference amount between the first relative position and the second relative position after correction in a lateral direction of the ego vehicle or the traveling road of the ego vehicle, as the difference amount.

3. The position detection apparatus according to claim 2,
wherein, when defining one to be corrected among the first relative positions and the second relative positions as relative positions of a correction object and defining one to be not corrected as relative positions of a non-correction object, the difference amount calculator calculates an approximate line passing through the two relative positions of the correction object close to the relative position of the non-correction object; and calculates a relative position on the approximate line whose relative position in the longitudinal direction coincide with a relative position of the non-correction object in the longitudinal direction, as the relative position of the correction object after correction.

4. The position detection apparatus according to claim 3,
wherein the difference amount calculator sets one with larger detection number of relative positions among the first relative positions and the second relative positions as the relative positions of the correction object, and sets one with smaller detection number of relative positions as the relative positions of the non-correction object.

5. The position detection apparatus according to claim 1,
wherein, when deviations between a plurality of difference amounts whose relative positions are close with each other are less than or equal to a deviation determination value, the reliability determiner determines that the plurality of difference amounts whose relative positions are close are the difference amounts calculated for the same object.

6. The position detection apparatus according to claim 1,
wherein the reliability determiner continuously sets a pair of the two difference amounts whose relative positions are close with each other from the plurality of difference amounts, while overlapping relative positions between the pairs; for each of the pairs of the two difference amounts, when a deviation between the two difference amounts is less than or equal to a deviation determination value, determines that the two difference amounts are the difference amounts calculated for the same object; and determines the group of the plurality of difference amounts calculated for the same object among the plurality of pairs of the two difference amounts whose relative positions are overlapped continuously.

7. The position detection apparatus according to claim 1,
wherein the reliability determiner sets an acceptable range, based on the plurality of difference amounts of the same object; and determines whether or not the reliability of the first relative positions and the second relative positions corresponding to the plurality of difference amounts of the same object is high, based on a comparison result between the plurality of difference amounts of the same object, and the acceptable range.

8. The position detection apparatus according to claim 7,
wherein the reliability determiner calculates a variation degree of the plurality of difference amounts of the same object; and sets the acceptable range, based on the plurality of difference amounts of the same object and the variation degree.

9. The position detection apparatus according to claim 7,
wherein the reliability determiner sets an upper limitation value and a lower limitation value, based on a detection characteristic of the first relative position by the first periphery information detector, and a detection characteristic of the second relative position by the second periphery information detector; and upper and lower limits the acceptable range with the upper limitation value and the lower limitation value.

10. The position detection apparatus according to claim 7,
wherein the reliability determiner determines whether or not the plurality of difference amounts of the same object are normal values as the difference amounts of the same object; and sets the acceptable range to a preliminarily set specified range, when determining to be not normal values.

11. The position detection apparatus according to claim 7,
wherein the reliability determiner calculates the final acceptable range by correcting the acceptable range of present calculation which is the acceptable range set based on the plurality of difference amounts of the same object calculated in a present calculation cycle, by the acceptable range calculated in a past calculation cycle for this same object.

12. The position detection apparatus according to claim 11,
wherein the reliability determiner calculates the final acceptable range by correcting the acceptable range of present calculation so as to suppress a change in the final acceptable range of the same object from the acceptable range calculated in the past calculation cycle for the same object.

13. The position detection apparatus according to claim 1,
wherein the reliability determiner determines whether or not the reliability of the first relative positions and the second relative positions corresponding to the plurality of difference amounts of the same object is high, based on a ratio of a number of the difference amounts which became within the acceptable range, with respect to a total number of the plurality of difference amounts of the same object.

14. The position detection apparatus according to claim 1,
wherein the plurality of periphery information detectors include any two or more of a position detection apparatus which detects a current position of the ego vehicle, one or more kinds of periphery monitoring apparatuses which monitor around the ego vehicle, a roadside machine which monitors a road, and a peripheral vehicle which exists around the ego vehicle.

15. The position detection apparatus according to claim 1, further comprising
a vehicle controller that controls a traveling of vehicle using the first relative positions and the second relative positions which were determined that the reliability is high.

16. The position detection apparatus according to claim 15,
wherein three or more the periphery information detectors are provided,
wherein the difference amount calculator sets a plurality of combinations of the first periphery information detector and the second periphery information detector from the three or more periphery information detectors; and calculates a plurality of the difference amounts for the each combination,
wherein the reliability determiner, for the each combination, determines whether or not the reliability of the first relative positions and the second relative positions corresponding to the plurality of difference amounts of the same object is high, based on the plurality of difference amounts, and
wherein the vehicle controller controls the traveling of vehicle using the first relative positions and the second relative positions which were determined that the reliability is high in any combination.

17. A position detection method that makes an arithmetic processor perform each following step, comprising:
a periphery information acquisition step of detecting, for each of a plurality of periphery information detectors, relative positions of a plurality of object parts existing around an ego vehicle with respect to the ego vehicle, based on detection information of the periphery information detector;
a difference amount calculation step of setting a first periphery information detector and a second periphery information detector to be determined, from the plurality of periphery information detectors; setting the relative positions of the plurality of object parts which were detected based on the detection information of the first periphery information detector, as a plurality of first relative positions; setting the relative positions of the plurality of object parts which were detected based on the detection information of the second periphery information detector, as a plurality of second relative positions; and calculating a difference amount between the first relative position and the second relative position, for each of pairs of the first relative position and the second relative position in which relative positions correspond with each other;
a reliability determination step of determining a group of a plurality of the difference amounts calculated for the same object, based on a plurality of the difference amounts, and determining whether or not the reliability of the first relative positions and the second relative positions corresponding to the plurality of difference amounts of the same object is high, based on the plurality of difference amounts of the same object of one group which was determined to be calculated for the same object.
